(19) United States
(12) Patent Application Publication
(10) Pub. No.: US 2007/0011015 A1
(43) Pub. Date: Jan. 11, 2007

(54) Automated system for assisting employees to comply with filing requirements

(75) Inventor: Loretta Emily Alkalay, Scarsdale, NY (US)

Correspondence Address: James J. Drew;Office of Center Counsel, FAA Technical Center, Atlantic City Int'l Airport, NJ, 08405, US

(73) Assignee: Government of the United States

(21) Appl. No.: 11/174,642

(22) Filed: Jul. 6, 2005

(51) Int. Cl. G06Q 99/00; G06F 7/00; G06F 17/00

(52) U.S. Cl. 705/1; 707/100

(57) ABSTRACT

An automated system and method for assisting federal employees and their managers to comply with regulations relating to filing financial disclosure forms. A program site is established on a computer network accessed by a computer terminal. The program site has databases listing employees and their managers, collections of notices that can be sent to employees and managers, collections of completed data forms, an assistance program that guides employees through a series of computer screens and that requires data to be entered correctly before the forms can be completed, a database of assets and prohibited assets, and a database of those employees that have failed to complete the forms or who possess prohibited assets, or both. The compliance program periodically reviews the database of non-compliant employees and employees with prohibited assets and transmits notices to employees and managers to insure compliance.

### STATEMENT OF GOVERNMENT INTEREST

The present invention may be made or used by or for the Government of the United States without the payment of any royalties thereon.

### FIELD OF THE INVENTION

The present invention relates generally to automated systems for completing and filing standardized forms, particularly those Financial Disclosure Forms that must be filed by certain Federal employees, and for reviewing those forms when completed.

### BACKGROUND

The U.S. Office of Government Ethics (OGE) is an office in the executive branch charged with the responsibility of preventing conflicts of interest on the part of Government employees, and of resolving those conflicts of interest that do occur. One tool that the OGE has developed to accomplish these tasks is a standardized form, the Confidential Financial Disclosure Report (OGE Form 450) that must be completed and filed each year by certain Federal Employees. Each such employee is required to provide certain information to assist the employing agency to determine if there are actual or potential conflicts of interest between the employee's official duties and her own financial interests. The agency officials responsible for monitoring compliance with these requirements has to identify which employees must file the forms, insure that the form has been filed within the filing period, take action if the employee has not filed, and review each submitted form for conflicts. If conflicts are identified, agency officials must address them with the employee, and the employee's supervisor or manager.

This process is resource intensive. Identification of those who had to file (which in an agency like the Federal Aviation Administration could number in the thousands), distribution of blank paper forms, accumulation of relevant data and completion of the form by the affected employee, hectoring those who failed to file, examining all the completed forms for conflicts, communicating with those with identified conflicts, plus completing all the interstitial stages in the process consumed great amounts of time and begged for an automated process to reduce the burden.

One of the greatest problems faced by both the filer and the agency official responsible for compliance is completing the form correctly and providing sufficient accurate information, on time, so that the data can be reviewed and acted on expeditiously.

### OBJECTS OF THE INVENTION

Accordingly, it is an object of the present invention to provide an automated system to assist employees in an organization to complete forms and to assist their managers in monitoring employee compliance with filing requirements.

It is also an object of the present invention to provide an automated system to facilitate compliance with Federal statutes, regulations, and executive orders related to conflicts of interest and standards of conduct for Federal employees.

It is also an object of the present invention to provide an automated system to facilitate communication between Federal managers and employees on issues involving responsibilities under various statutes, regulations and executive orders dealing with Federal employee standards of conduct and conflicts of interest.

It is a further object of the present invention to provide an automated system to assist Federal employees to complete those financial disclosure forms mandated by the U.S. Office of Government Ethics.

It is a still further object of the present invention to provide an automated system to help Federal managers to monitor their employees' compliance with disclosure requirements.

It is an even further object of the present invention to provide an automated system to assist Federal Ethics Officers to review completed OGE forms to detect real and potential conflicts of interest.

### SUMMARY

Briefly, the present invention is a computer-based system that identifies those Federal employees within an installation that are required to file Confidential Financial Disclosure Reports (at present, OGE Form 450), contacts these employees through a computer network (email), assists the employee in providing data input to the system that will be used to complete the Form 450 automatically, compares the data provided to data bases containing prohibited financial holdings (such as stocks, bonds, and mutual funds) for both the filer and her spouse and dependents, flags such prohibited holdings for action by the facility Ethics Officer, automatically notifies employees if they (or their spouse or dependent) have a prohibited holding, tabulates those employees that have filed and those who are yet to file within the reporting period, periodically issues email notices to those employees who have failed to file, and advises their manager of their status.

### BRIEF DESCRIPTION OF THE DRAWING

FIG. 1 is a block diagram of the automated system described in this specification.

### DETAILED DESCRIPTION OF THE INVENTION

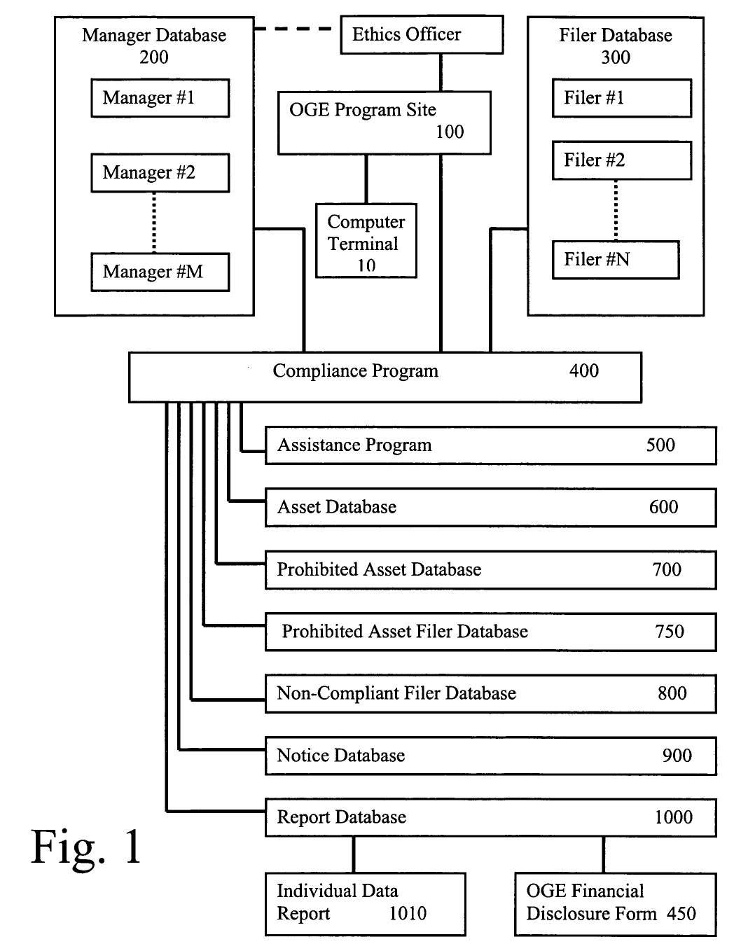

Referring to FIG. 1 in the drawing, the designated facility Ethics Officer establishes on a computer network a Program Site 100 that contains, at least, a Manager Database 200, a Filer Database 300, a Compliance Program 400, an Assistance Program 500, an Asset Database 600, a Prohibited Asset Database 700, a Non-Compliant Filer Database 800, a Notice Database 900, and an Report Database 1000. Within the Report Database 1000, are a number of Individual Data Reports 1010 and completed OGE Financial Disclosure Forms 450. A computer terminal 10 accesses the Program Site 100.

The various interactions among the various databases and programs may be established using existing computer programming languages, such as Microsoft's Visual Studio, and commercially available database management systems, such as Microsoft's Visual FoxPro.

Each Manager in Manager Database 200 determines which of his or her employees are required to file an OGE Form 450, [“FILER”], and enters the names and other relevant information (e.g. email addresses) for each FILER in the Mandatory Filer Database 300. Generally, in an organization, not all employees are required to file every form. An employee who has been designated by her manager as subject to the filing requirement may be referred to as a FILER and all such employees as FILERS.

The Ethics Officer prepares a list of assets consisting of those stocks, bonds, mutual funds and other such financial holdings, taken from common sources, such as a Standard and Poor's Directory, and enters this list into the Asset Database 600. Each asset listed in the Asset Database 600 consists of the proper name and associated symbol for the asset to assist the FILER and the Ethics Officer to identify exactly the asset listed.

The Ethics Officer prepares a list of prohibited assets, that is, those stocks, bonds, mutual funds, etc., ownership of which has been determined to present a conflict of interest for agency employees, their spouses, and dependents and enters this list into the Prohibited Asset Database 700.

The Ethics Officer prepares a set of standard letters and notices that may be sent to FILERS to provide information and instructions and enters them into the Notice Database 900. Specific information and instructions for a specific FILER may be selected by the Ethics Officer after review of the Individual Data Reports 1010 and the OGE Financial Disclosure Forms 450, or may be generated automatically by the Compliance Program 400.

The Compliance Program 400 accesses the Filer Database 300 and the Notice Database 900 and transmits to each FILER a notice advising each FILER of his or her responsibility to comply with the OGE requirements and directing each FILER to the OGE Program Site 100.

The FILER accesses the OGE Program Site 100 and downloads the Assistance Program 500 to his or her computer terminal 10.

The FILER is guided through the series of computer screens presented by the Assistance Program 500 and by responding to the questions and selecting among possible choices presented on each computer screen creates an Individual Data Report 1010. The Assistance Program 500 allows the FILER to periodically store and retrieve her Individual Data Report 1010 and permits her to input data over several sessions until it is complete. The FILER may also choose to abandon and delete her incomplete Individual Data Report 1010 and create a new one.

The Assistance Program 500 insures that the FILER answers each question and makes an appropriate selection on each computer screen before it permits the FILER to proceed to the next screen. When the FILER has successfully completed all the computer screens, the Assistance Program 500 enters data from the Individual Data Report 1010 into the corresponding blank spaces in the OGE Financial Disclosure Form 450 for the FILER.

The Assistance Program 500 provides the completed OGE Financial Disclosure Form 450 to the FILER for printing.

The FILER prints out the completed OGE Financial Disclosure Form 450, signs it, and submits it to the Ethics Officer. This step can be eliminated in a system that provides for electronic signatures.

The Assistance Program 500 stores the completed Individual Data Report 1010 and the OGE Financial Disclosure Form 450 for the FILER in the Report Database 1000.

The Ethics Officer reviews the OGE Financial Disclosure Form 450 submitted by the FILER and determines which of the standard letters or notices must be sent to the FILER. The Ethics Officer selects the appropriate notice from the Notice Database 900 and directs the Compliance Program 400 to send the notice to the FILER. The selection and transmission of the appropriate notice can be automated and completed by the Compliance Program 400 without any action of the Ethics Officer, if so desired.

The Compliance Program 400 periodically compares the contents of the Individual Data Report Database 1000 with the Filer Database 300, identifies those FILERS who have not yet completed their Individual Data Reports 1010 and their OGE Financial Disclosure Form 450 and enters the names of those noncompliant FILERS into the Noncompliant Filer Database 800.

The Compliance Program 400 periodically sends appropriate messages from the Notice Database 900 to the managers of those noncompliant FILERS and to the noncompliant FILERS themselves to urge appropriate actions. This automated process of periodic notification continues throughout the filing period, and if necessary, beyond the period to insure compliance. For enforcement purposes, a continuous record of notification is generated and stored in the Mandatory Filer Database 300, or the Noncompliant Filer Database 800, or some other appropriate database as may be determined by the managers or the Ethics Officer.

This simple procedure, described above, does not take full advantage of the capabilities of an computer-based automated system. Further enhancements to this automated system allow even more efficiencies. In a more advanced system, the Compliance Program 400 compares the data in the Individual Data Report 1010 to the data in the Prohibited Asset Database 700 and, if any prohibited assets are encountered, lists the associated FILER in the Prohibited Asset Filer Database 950. The Notice Database 900 generates the appropriate notice and transmits it to the FILER to advise her of this potential conflict. The Assistance Program 500 can be written to advise the FILER of the potential conflict immediately as she completes the appropriate computer screen dealing with assets, or not, as the Ethics Officer may determine. The Compliance Program 400 notifies the Ethics Officer, who for convenience is listed in the Manager Database 200, identifies the associated FILER and the prohibited assets. If approved by the Ethics Officer, the Compliance Program 400 may inform the relevant manager as well.

One may appreciate that the system and method as herein described may find various applications and accordingly modifications may be made to the system and method described without departing from the scope of the invention as broadly conceived.

I claim:

1. An automated system to assist employees in an organization to complete forms, said system comprising:
a. A computer network;
b. At least one computer terminal capable of accessing said computer network;
c. A program site resident on said computer network, said program site comprising:
i. an employee database containing the name of and information on each employee;
ii. a manager database containing the name of and information on each manager: and
iii. a compliance program further comprising:
A. an assistance program,
B. a report database containing completed data reports,
C. a non-compliant employee database containing the names of those employees who have not yet completed a data report, and
D. a notice database containing a plurality of notices,
wherein said compliance program extracts a first notice from said notice database and sends said first notice to each employee listed in said employee database via said computer network to said computer terminal,
wherein said first notice directs each employee listed in said employee database to access said program site and to download said assistance program to said computer terminal,
wherein said assistance program provides instructions and guidance sufficient to complete said data report, periodically reviews said data report for errors and completeness, and refuses to upload said data report to said report database if said data report contains errors or is incomplete,
wherein said assistance program uploads said data report to said report database when said data report is correct and complete and associates in said report database said data report with the employee who completed it,
wherein said compliance program generates a completed form from said data report and transmits said form to said computer terminal via said computer network,
wherein said compliance program periodically accesses said report database, extracts the names of those employees who have completed said data report, compares the names of those employees who have completed said data report with the names of employees in said employee data base, compiles a list of those employees who have not yet completed said data report and stores said list in said non-compliant employee database, and
wherein said compliance program periodically accesses said non-compliant employee database, extracts the names of those employees who have not completed said data report, extracts a second notice from said notice database, and transmits said second notice to those employees who have not yet completed said data report advising them of their obligation to do so, extracts from said employee database the names of their respective managers, extracts from said notice data base a third notice advising each respective manager that the employee is non-compliant, and transmits said third notice to said respective manager of said employees who have not completed said data report.

2. The automated system of claim 1, wherein said compliance program further comprises:
E. an asset database containing a list of assets
and
wherein said assistance program extracts and displays the list of assets from the asset database to assist the employee in identifying assets in which the employee may have an interest.

3. The automated system of claim 2, wherein said compliance program further comprises:
F. a prohibited asset database containing a list of prohibited assets, and
G. a prohibited asset employee database containing the names of those employees who have an interest in a prohibited asset
and
wherein said compliance program examines said data report, compares the assets reported in said data report to said list of prohibited assets, and if any asset reported in said data report matches any asset listed on said list of prohibited assets, enters the name of the employee associated with said data report into said prohibited asset employee database and associates each such identified prohibited asset with the name of the employee, and
wherein said compliance program periodically accesses said prohibited asset employee database, extracts the names of those employees who have an interest in a prohibited asset, extracts a fourth notice from said notice database, and transmits said fourth notice to those employees who have an interest in a prohibited asset advising them of their obligations with respect to each such prohibited asset, extracts from said employee database the names of their respective managers, extracts from said notice data base a fifth notice advising each respective manager that the employee has an interest in a prohibited asset and transmits said fifth notice to said respective manager of said employees who has an interest in prohibited asset.

4. An automated system to assist federal employees at a facility to complete mandatory financial disclosure forms relating to possible conflicts of interest and to assist federal managers to monitor compliance, said system comprising:
a. A computer network;
b. At least one computer terminal capable of accessing said computer network; and
c. A program site resident on said computer network, said program site comprising
i. an employee database containing the names of and information on each federal employee,
ii. a manager database containing names of and information on each manager, and
iii. a compliance program further comprising:
A. an assistance program,
B. an asset database containing a list of assets,
C. a prohibited asset database containing a list of prohibited assets,
D. a prohibited asset employee database containing the names of those federal employees who have an interest in a prohibited asset,
E. a report database containing completed data reports,
F. a non-compliant employee database containing a list of those federal employees that have not yet completed a data report, and
G. a notice database containing a plurality of notices,
wherein said compliance program extracts a first notice from said notice database and sends said first notice to each federal employee listed in said employee database via said computer network to said computer terminal,
wherein said first notice directs each federal employee listed in said employee database to access said program site and to download said assistance program to said computer terminal,
wherein said assistance program provides instructions and guidance sufficient to complete said data report, periodically reviews said data report for errors and completeness, and refuses to upload said data report to said report database if said data report is incorrect or incomplete,
wherein said assistance program extracts and displays the list of assets from the asset database to assist the federal employee in identifying assets in which the federal employee may have an interest,
wherein said assistance program uploads said data report to said report database when said data report is correct and complete and associates in said report database said data report with the employee who completed it,
wherein said compliance program examines said data report, compares the assets reported in said data report to said list of prohibited assets, and if any asset reported in said data report matches any asset listed on said list of prohibited assets, enters the name of the federal employee associated with said data report into said prohibited asset employee database and associates each such identified prohibited asset with the name of the federal employee,
wherein said compliance program generates a completed financial disclosure form from said data report and sends said form to said computer terminal via said computer network,
wherein said compliance program periodically accesses said report database, extracts the names of those federal employees who have completed said data report, compares the names of those federal employees who have completed said data report with the names of federal employees in said employee data base, compiles a list of those federal employees who have not yet completed said data report and stores said list in the non-compliant employee database,
wherein said compliance program periodically accesses said non-compliant employee database, extracts the names of those federal employees who have not completed said data report, extracts a second notice from said notice database, and transmits said second notice to those federal employees who have not yet completed said data report advising them of their obligation to do so, extracts from said employee database the names of their respective managers, extracts from said notice data base a third notice advising each respective manager that the federal employee is non-compliant, and transmits said third notice to said respective manager of said federal employees who have not completed said data report, and
wherein said compliance program periodically accesses said prohibited asset employee database, extracts the names of those federal employees who have an interest in a prohibited asset, extracts a fourth notice from said notice database, and transmits said fourth notice to those federal employees who have an interest in a prohibited asset advising them of their obligations with respect to said prohibited asset, extracts from said employee database the names of their respective managers, extracts from said notice data base a fifth notice advising each respective manager that the federal employee has an interest in a prohibited asset and transmits said fifth notice to said respective manager of said federal employees who has an interest in prohibited asset.

5. An automated method to assist employees in an organization to complete forms, said method comprising the steps of:
a. establishing a program site resident on a computer network accessible by at least one computer terminal, said program site comprising:
i. an employee database containing the name of and information on each employee;
ii. a manager database containing the name of and information on each manager: and
iii. a compliance program further comprising
A. an assistance program,
B. a report database containing completed data reports,
C. a non-compliant employee database containing the names of those employees who have not yet completed a data report, and
D. a notice database containing a plurality of notices,
b. extracting a first notice from said notice database and sending said first notice to each employee listed in said employee database via said computer network to said computer terminal,
c. directing each employee listed in said employee database to access said program site and to download said assistance program to said computer terminal,
d. providing instructions and guidance sufficient to complete said data report, periodically reviewing said data report for errors and completeness, and refusing to upload said data report to said report database if said data report contains errors or is incomplete,
e. uploading said data report to said report database when said data report is correct and complete and associating in said report database said data report with the employee who completed it,
f. generating a completed form from said data report and transmitting said form to said computer terminal via said computer network,
g. periodically accessing said report database, extracting the names of those employees who have completed said data report, comparing the names of those employees who have completed said data report with the names of employees in said employee data base, compiling a list of those employees who have not yet completed said data report and storing said list in said non-compliant employee database, and
h. periodically accessing said non-compliant employee database, extracting the names of those employees who have not completed said data report, extracting a second notice from said notice database, and transmitting said second notice to those employees who have not yet completed said data report advising them of their obligation to do so, extracting from said employee database the names of their respective managers, extracts from said notice data base a third notice advising each respective manager that the employee is non-compliant, and transmitting said third notice to said respective manager of said employees who have not completed said data report.

6. The automated method of claim 5 wherein said compliance program further comprises:
E. an asset database containing a list of assets
and wherein said method further comprises the step of:
i. extracting and displaying the list of assets from the asset database to assist the employee in identifying assets in which the employee may have an interest.

7. The automated method of claim 6, wherein said compliance program further comprises:
F. a prohibited asset database containing a list of prohibited assets, and G. a prohibited asset employee database containing the names of those employees who have an interest in a prohibited asset,
and wherein said method further comprises the steps of:
j. examining said data report, comparing the assets reported in said data report to said list of prohibited assets, and if any asset reported in said data report matches any asset listed on said list of prohibited assets, entering the name of the employee associated with said data report into said prohibited asset employee database and associating each such identified prohibited asset with the name of the employee, and
k. periodically accessing said prohibited asset employee database, extracting the names of those federal employees who have an interest in a prohibited asset, extracting a fourth notice from said notice database, and transmitting said fourth notice to those federal employees who have an interest in a prohibited asset advising them of their obligations with respect to said prohibited asset, extracting from said employee database the names of their respective managers, extracting from said notice data base a fifth notice advising each respective manager that the federal employee has an interest in a prohibited asset and transmitting said fifth notice to said respective manager of said federal employees who has an interest in said prohibited asset.

8. An automated method to assist federal employees at a facility to complete mandatory financial disclosure forms relating to possible conflicts of interest and to assist federal managers to monitor compliance, said method comprising the steps of:
a. establishing a program site resident on a computer network accessible by at least one computer terminal, said program site comprising:
i. an employee database containing the name of and information on each federal employee,
ii. a manager database containing the name of and information on each federal manager within an organization, and
iii. a compliance program further comprising:
A. an assistance program,
B. an asset database containing a list of assets,
C. a prohibited asset database containing a list of prohibited assets,
D. a prohibited asset employee database containing the names of those federal employees who have an interest in a prohibited asset,
E. a report database containing completed data reports,
F. a non-compliant employee database containing a list of those federal employees that have not yet completed a data report, and
G. a notice database containing a plurality of notices,
b. extracting a first notice from said notice database and sending said first notice to each federal employee listed in said employee database via said computer network to said computer terminal,
c. directing each federal employee listed in said employee database to access said program site and to download said assistance program to said computer terminal,
d. providing instructions and guidance sufficient to complete said data report, periodically reviewing said data report for errors and completeness, and refusing to upload said data report to said report database if said data report is incorrect or incomplete,
e. extracting and displaying the list of assets from the asset database to assist the federal employee in identifying assets in which the federal employee may have an interest,
f. uploading said data report to said report database when said data report is correct and complete,
g. examining said data report, comparing the assets reported in said data report to said list of prohibited assets, and if any asset reported in said data report matches any asset listed on said list of prohibited assets, entering the name of the federal employee associated with said data report into said prohibited asset employee database and associating each such identified prohibited asset with the name of the federal employee,
h. generating a completed financial disclosure form from said data report and transmitting said form to said computer terminal via said computer network,
i. periodically accessing said report database, extracting the names of those federal employees who have completed said data report, comparing the names of those federal employees who have completed said data report with the names of federal employees in said employee data base, compiling a list of those federal employees who have not yet completed said data report and stores said list in the non-compliant employee database,
j. periodically accessing said non-compliant employee database, extracting the names of those federal employees who have not completed said data report, extracting a second notice from said notice database, and transmitting said second notice to those federal employees who have not yet completed said data report advising them of their obligation to do so, extracting from said employee database the names of their respective managers, extracting from said notice data base a third notice advising each respective manager that the federal employee is non-compliant, and transmitting said third notice to said respective manager of said federal employees who have not completed said data report, and
k. periodically accessing said prohibited asset employee database, extracting the names of those federal employees who have an interest in a prohibited asset, extracting a fourth notice from said notice database, and transmitting said fourth notice to those federal employees who have an interest in a prohibited asset advising them of their obligations with respect to said prohibited asset, extracting from said employee database the names of their respective managers, extracting from said notice data base a fifth notice advising each respective manager that the federal employee has an interest in a prohibited asset and transmitting said fifth notice to said respective manager of said federal employees who has an interest in said prohibited asset.
